(19) United States
(12) Patent Application Publication
(10) Pub. No.: US 2018/0179950 A1
(43) Pub. Date: Jun. 28, 2018

(54) TURBINE ENGINE ASSEMBLY INCLUDING A ROTATING DETONATION COMBUSTOR

(71) Applicant: General Electric Company, Schenectady, NY (US)

(72) Inventors: Andrew Maxwell Peter, Saratoga Springs, NY (US); Peter Daniel Silkowski, Scotia, NY (US); Thomas Michael Lavertu, Clifton Park, NY (US); Venkat Eswarlu Tangirala, Niskayuna, NY (US); Douglas Carl Hofer, Clifton Park, NY (US)

(21) Appl. No.: 15/390,024

(22) Filed: Dec. 23, 2016

(51) Int. Cl. F02C 3/16; F02C 5/02; F23R 3/58

(52) U.S. Cl. CPC F02C 3/16; F02C 5/02; F05D 2240/24; F05D 2220/32; F05D 2240/35; F23R 3/58

(57) ABSTRACT

A turbine engine assembly including a plurality of rotating detonation combustors configured for a rotating detonation process to occur to produce a flow of combustion gas. The plurality of rotating detonation combustors are oriented such that the flow of combustion gas discharged therefrom flows helically relative to a centerline of the turbine engine assembly. The assembly also includes a turbine coupled downstream from the plurality of rotating detonation combustors. The turbine is configured to receive the flow of combustion gas.

### BACKGROUND

The present disclosure relates generally to rotating detonation combustion systems and, more specifically, to a turbine engine assembly that efficiently converts the energy of exhaust gas produced by detonative combustion into shaft mechanical work via a turbine.

In rotating detonation engines and, more specifically, in rotating detonation combustors, a mixture of fuel and an oxidizer is ignited such that combustion products are formed. For example, the combustion process begins when the fuel-oxidizer mixture in a tube or a pipe structure is ignited via a spark or another suitable ignition source to generate a compression wave. The compression wave is followed by a chemical reaction that transitions the compression wave to a detonation wave. The detonation wave enters a combustion chamber of the rotating detonation combustor and travels along the combustion chamber. Air and fuel are separately fed into the rotating detonation combustion chamber and are consumed by the detonation wave. As the detonation wave consumes air and fuel, combustion products traveling along the combustion chamber accelerate and are discharged from the combustion chamber.

In at least some known gas turbines including a can-annular combustor arrangement, a first set of guide vanes is coupled between an outlet of the compressor and an inlet of the combustor. The first set of guide vanes facilitates reducing swirl (i.e., removing bulk swirl) of a flow of air discharged from the compressor such that the flow of air is channeled in a substantially axial direction towards the combustor. A second set of guide vanes (i.e., turbine nozzle vanes) is coupled between an outlet of the combustor and an inlet of the turbine. The second set of guide vanes facilitates increasing swirl (i.e., reintroducing bulk swirl) of a flow of combustion gas discharged from the combustor such that flow angle requirements for the inlet of the turbine are satisfied. However, redirecting the flow of combustion gas with the sets of guide vanes increases operating inefficiencies of the gas turbine. Moreover, including additional components, such as the set of guide vanes, generally adds weight, cost, and complexity to a turbine engine assembly.

### BRIEF DESCRIPTION

In one aspect, a turbine engine assembly is provided. The turbine engine assembly includes a plurality of rotating detonation combustors configured for a rotating detonation process to occur to produce a flow of combustion gas. The plurality of rotating detonation combustors are oriented such that the flow of combustion gas discharged therefrom flows helically relative to a centerline of the turbine engine assembly. The assembly also includes a turbine coupled downstream from the plurality of rotating detonation combustors. The turbine is configured to receive the flow of combustion gas.

In another aspect, a rotating detonation combustor is provided. The combustor includes a center body and a radially outer side wall extending about the center body such that a combustion chamber is at least partially defined therebetween. At least a portion of the radially outer side wall is oriented to converge towards the center body such that the combustion chamber includes an annular portion and a throttling portion positioned downstream from the annular portion.

In yet another aspect, a rotating detonation combustion system for use in a turbine engine assembly is provided. The system includes a plurality of rotating detonation combustors configured for a rotating detonation process to occur to produce a flow of combustion gas and a plurality of flow conduits coupled in flow communication with the plurality of rotating detonation combustors. The plurality of rotating detonation combustors and the plurality of flow conduits are oriented such that the flow of combustion gas discharged from the plurality of flow conduits flows helically relative to a centerline of the turbine engine assembly.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an exemplary combined cycle power generation system;

FIG. 2 is a schematic illustration of an exemplary rotating detonation combustion system that may be used in the combined cycle power generation system shown in FIG. 1;

FIG. 3 is a schematic illustration of an exemplary rotating detonation combustor that may be used in the rotating detonation combustion system shown in FIG. 2; and

FIG. 4 is a schematic illustration of an alternative rotating detonation combustor that may be used in the rotating detonation combustion system shown in FIG. 2.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “axial” and “axially” refer to directions and orientations that extend substantially parallel to a centerline of the turbine engine assembly or the rotating detonation combustor. Moreover, the terms “radial” and “radially” refer to directions and orientations that extend substantially perpendicular to the centerline of the turbine engine assembly or the rotating detonation combustor. In addition, as used herein, the terms “circumferential” and “circumferentially” refer to directions and orientations that extend arcuately about the centerline of the turbine engine assembly or the rotating detonation combustor. In addition, as used herein, the terms “tangential” and “tangentially” refer to directions and orientations that extend substantially perpendicular relative to a radial axis of the turbine engine assembly or the rotating detonation combustor.

Embodiments of the present disclosure relate to a turbine engine assembly that efficiently converts the energy of exhaust gas produced by detonative combustion into shaft mechanical work via a turbine. More specifically, the turbine engine assembly described herein includes a plurality of rotating detonation combustors that are oriented to discharge a flow of combustion gas helically relative to a centerline of the turbine engine assembly. Discharging the flow of combustion gas helically facilitates satisfying flow angle requirements of an inlet of a turbine coupled downstream from the plurality of rotating detonation combustors.

Moreover, because the flow velocity of the combustion gas is comparatively large relative to traditional can-annular combustor arrangements, the degree of acceleration and turning required in the turbine nozzle vanes is reduced, and their function can be integrated within the rotating detonation combustor system. This integration facilitates elimination of transition piece seals and associated leakage flows, nozzle leading edges and associated cooling flows, and reduces the overall acceleration and turning requirements of the turbine nozzle vanes, which further reduces cooling flow requirements. In addition, discharging combustion gas helically, rather than axially, facilitates the removal of separate turbine nozzle vanes positioned between the combustors and the turbine. As such, the kinetic energy of the flow of combustion gas is preserved, and the complexity of the turbine engine is reduced by eliminating compressor bleed air cooling requirements associated with transition piece seals and turbine nozzle vanes, for example.

As used herein, “detonation” and “quasi-detonation” may be used interchangeably. Typical embodiments of detonation chambers include a means of igniting a fuel/oxidizer mixture, for example a fuel/air mixture, and a confining chamber, in which pressure wave fronts initiated by the ignition process coalesce to produce a detonation wave. Each detonation or quasi-detonation is initiated either by external ignition, such as spark discharge or laser pulse, or by gas dynamic processes, such as shock focusing, autoignition or by another detonation via cross-firing. The geometry of the detonation chamber is such that the pressure rise of the detonation wave expels combustion products out the detonation chamber exhaust to produce a thrust force. In addition, rotating detonation combustors are designed such that a substantially continuous detonation wave is produced and discharged therefrom. As known to those skilled in the art, detonation may be accomplished in a number of types of detonation chambers, including detonation tubes, shock tubes, resonating detonation cavities, and annular detonation chambers.

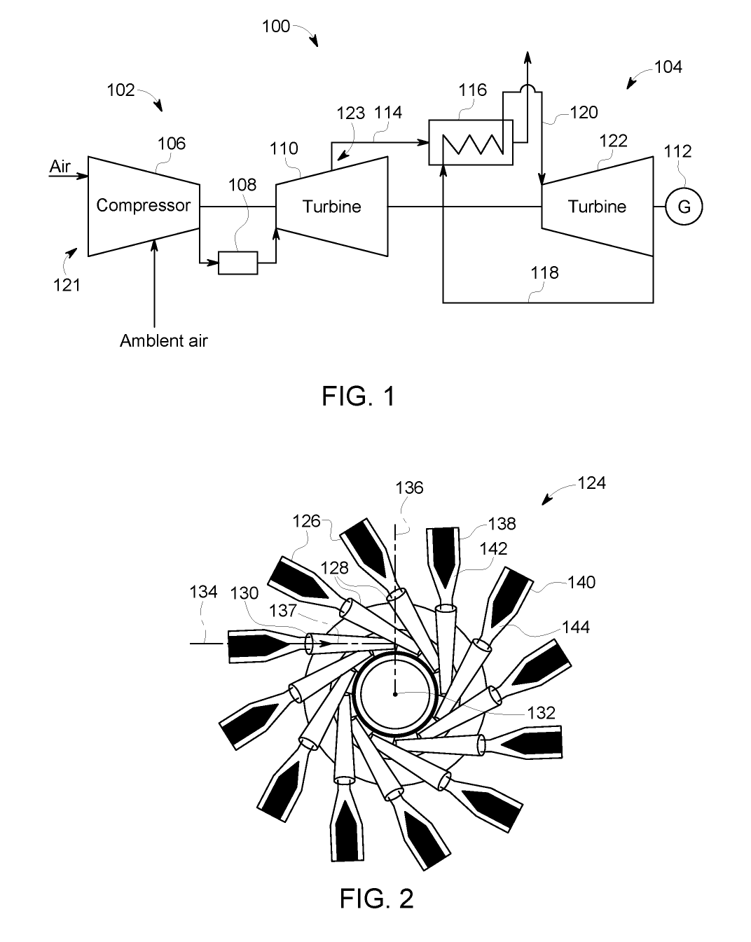

FIG. 1 is a schematic illustration of an exemplary combined cycle power generation system 100. Power generation system 100 includes a gas turbine engine assembly 102 and a steam turbine engine assembly 104. Gas turbine engine assembly 102 includes a compressor 106, a combustor 108, and a first turbine 110 powered by expanding hot gas produced in combustor 108 for driving an electrical generator 112. Gas turbine engine assembly 102 may be used in a stand-alone simple cycle configuration for power generation or mechanical drive applications. In the exemplary embodiment, exhaust gas 114 is channeled from first turbine 110 towards a heat recovery steam generator (HRSG) 116 for recovering waste heat from exhaust gas 114. More specifically, HRSG 116 transfers heat from exhaust gas 114 to water/steam 118 channeled through HRSG 116 to produce steam 120. Steam turbine engine assembly 104 includes a second turbine 122 that receives steam 120, which powers second turbine 122 for further driving electrical generator 112.

In operation, air enters gas turbine engine assembly 102 through an intake 121 and is channeled through multiple stages of compressor 106 towards combustor 108. Compressor 106 compresses the air and the highly compressed air is channeled from compressor 106 towards combustor 108 and mixed with fuel. The fuel-air mixture is combusted within combustor 108. High temperature combustion gas generated by combustor 108 is channeled towards first turbine 110. Exhaust gas 114 is subsequently discharged from first turbine 110 through an exhaust 123.

FIG. 2 is a perspective illustration of an exemplary rotating detonation combustion (RDC) system 124 that may be used in combined cycle power generation system 100 (shown in FIG. 1). In the exemplary embodiment, RDC system 124 includes a plurality of rotating detonation combustors 126 and a plurality of flow conduits 128 coupled to the plurality of rotating detonation combustors 126. As described above, the plurality of rotating detonation combustors 126 combust a fuel-air mixture (not shown in FIG. 2) to produce a flow of combustion gas 130. The plurality of rotating detonation combustors 126 are oriented such that the flow of combustion gas 130 discharged therefrom flows helically relative to an axial centerline 132 of gas turbine engine assembly 102 (shown in FIG. 1). More specifically, each rotating detonation combustor 126 has a longitudinal centerline 134, and each rotating detonation combustor 126 is oriented such that longitudinal centerline 134 is oriented tangentially relative to a radial axis 136 of gas turbine engine assembly 102. As such, as will be explained in more detail below, orienting rotating detonation combustors 126 with a circumferential or tangential component facilitates satisfying turbine inlet flow angle requirements for first turbine 110 (shown in FIG. 1) coupled downstream from the plurality of rotating detonation combustors 126. As used herein, “flow angle” is defined as a ratio of circumferential or tangential velocity to axial velocity of a flow of fluid.

In alternative embodiments, rotating detonation combustors 126 may be oriented at other angles relative to the radial axis 136. For example, the angle defined between longitudinal centerline 134 and radial axis 136 is defined within a range between about 0 degrees and about 180 degrees, between about 30 degrees and about 150 degrees, between about 60 degrees and about 120 degrees, between about 60 degrees and about 90 degrees, or between about 75 degrees and about 90 degrees.

The plurality of flow conduits 128 are coupled in flow communication with the plurality of rotating detonation combustors 126, and flow conduits 128 channel the flow of combustion gas 130 from the plurality of rotating detonation combustors 126 towards first turbine 110. In addition, the plurality of rotating detonation combustors 126 and the plurality of flow conduits 128 are arranged circumferentially relative to axial centerline 132. In one embodiment, gas turbine engine assembly 102 includes rotating detonation combustors 126 and flow conduits 128 in a one-to-one ratio such that a single flow conduit 128 extends from each rotating detonation combustor 126. As such, backflow of combustion gas 130 is restricted from spreading between adjacent rotating detonation combustors 126. Alternatively, more than one rotating detonation combustor 126 is coupled in flow communication with a single flow conduit 128.

As described above, the plurality of rotating detonation combustors 126 are oriented such that the flow of combustion gas 130 discharged therefrom flows helically relative to axial centerline 132 to facilitate satisfying flow angle requirements of first turbine 110. More specifically, first turbine 110 has a turbine entrance flow angle defined within a predetermined range. For example, first turbine 110 includes a plurality of rotor blades (not shown) that rotate relative to axial centerline 132, but otherwise have a fixed orientation relative to radial axis 136. The fixed orientation of the plurality of rotor blades define the turbine entrance flow angle of first turbine 110 such that combustion gas 130 channeled towards first turbine 110 needs to have a flow angle within the predetermined range to satisfy the flow angle requirements of first turbine 110. As such, in one embodiment, the plurality of flow conduits 128 are oriented to further facilitate channeling combustion gas 130 towards first turbine 110 at a predefined flow angle.

Flow conduits 128 are oriented at an angle with respect to a radial axis 136. Specifically, the angle defines the angular orientation of a conduit centerline 137 relative to radial axis 136. In the exemplary embodiment, the angle is approximately 90 degrees such that flow conduits 128 are oriented substantially tangentially. In alternative embodiments, flow conduits 128 may be oriented at other angles relative to the radial axis 136. For example, the angle defined between conduit centerline 137 and radial axis 136 is defined within a range between about 0 degrees and about 180 degrees, between about 30 degrees and about 150 degrees, between about 60 degrees and about 120 degrees, between about 60 degrees and about 90 degrees, or between about 75 degrees and about 90 degrees. As described above, the orientation of flow conduits 128 imparts a circumferential velocity component onto the flow of combustion gas 130. As such, flow conduits 128 are oriented at an angle to facilitate obviating first stage turbine nozzles, thereby decreasing the weight and complexity of the turbine 110.

For example, in the exemplary embodiment, the plurality of flow conduits 128 are oriented such that the flow of combustion gas 130 is discharged therefrom at a flow angle defined within the predetermined range. More specifically, in some embodiments, the plurality of flow conduits 128 receive the flow of combustion gas 130 from rotating detonation combustors 126 having a first flow angle, and discharge the flow of combustion gas 130 at a second flow angle different from the first flow angle. As such, if necessary, the plurality of flow conduits 128 are oriented to provide supplemental turning and deflection of combustion gas 130 before entering first turbine 110.

Moreover, in some embodiments, at least one rotating detonation combustor 126 in the plurality of rotating detonation combustors 126 is sized differently from other rotating detonation combustors 126 in the plurality. More specifically, in the exemplary embodiment, the plurality of rotating detonation combustors 126 includes a first rotating detonation combustor 138 and a second rotating detonation combustor 140. First rotating detonation combustor 138 includes a first combustion chamber 142 and second rotating detonation combustor 140 includes a second combustion chamber 144. First rotating detonation combustor 138 and second rotating detonation combustor 140 are sized differently such that first combustion chamber 142 has a greater diameter than second combustion chamber 144. As such, the frequency of a detonation wave (not shown) produced and discharged from first rotating detonation combustor 138 is different from a detonation wave produced and discharged from second rotating detonation combustor 140. Moreover, as such, rotor blades of first turbine 110 are impinged by pressure pulses having different frequencies, thereby facilitating an increase in high cycle fatigue life of gas turbine engine assembly 102.

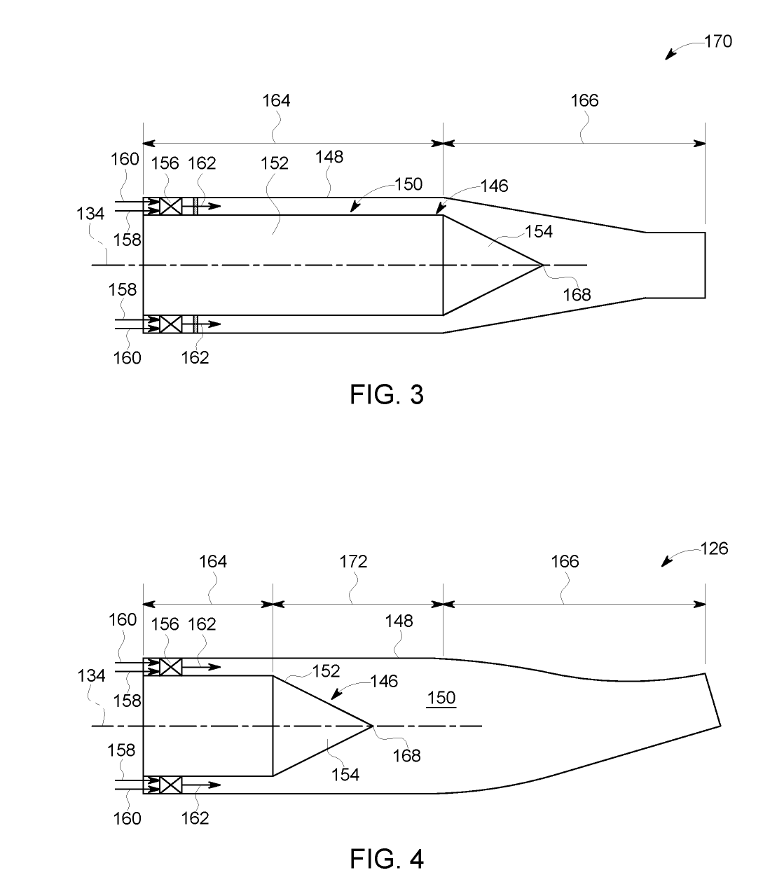

FIG. 3 is a schematic illustration of an exemplary rotating detonation combustor 126 that may be used in RDC system 124 (shown in FIG. 2). In the exemplary embodiment, rotating detonation combustor 126 (i.e., combustor 108 (shown in FIG. 1)) includes a center body 146 and a radially outer side wall 148 extending circumferentially about center body 146 such that a combustion chamber 150 is at least partially defined therebetween. Center body 146 includes a cylindrical portion 152 and a tapered portion 154 extending from cylindrical portion 152. In addition, rotating detonation combustor 126 includes a fuel-air mixer 156 coupled within combustion chamber 150. Fuel-air mixer 156 receives fuel 158 and air 160, and rotating detonation combustor 126 combusts a fuel-air mixture 162 discharged from fuel-air mixer 156.

In further embodiments, combustion chamber 150 is any suitable geometric shape and does not necessarily include an inner liner and/or center body. For example, in some embodiments, combustion chamber 150 is substantially cylindrical.

In the exemplary embodiment, at least a portion of radially outer side wall 148 is oriented to converge towards center body 146 such that combustion chamber 150 includes an annular portion 164 and a throttling portion 166 positioned downstream from annular portion 164. More specifically, radially outer side wall 148 is oriented obliquely relative to a longitudinal centerline 134 of rotating detonation combustor 126. Radially outer side wall 148 also extends past a trailing edge 168 of center body 146 relative to longitudinal centerline 134. Trailing edge 168 terminates downstream from annular portion 164 such that at least a portion of throttling portion has a non-annular flow passage. As such, combustion chamber 150 includes annular portion 164 having an annular geometry and throttling portion 166 transitioning from an annular geometry to a non-annular and open geometry. Tapered portion 154 and the convergent portion of radially outer side wall 148 need not originate at the same axial point along longitudinal centerline 134.

In the exemplary embodiment, combustion chamber 150 also has an overall cross-sectional flow area that progressively decreases along longitudinal centerline 134 of rotating detonation combustor 126. More specifically, flow conduits 128 progressively reduce in cross-sectional size along longitudinal centerline 134 such that throttling portion 166 has a cross-sectional flow area less than a cross-sectional flow area of annular portion 164. The cross-sectional flow area of throttling portion 166 is progressively reduced as radially outer side wall 148 extends downstream from annular portion 164. As such, the velocity of the flow of combustion gas 130 channeled through rotating detonation combustor 126 and, more specifically, through throttling portion 166 is increased.

FIG. 4 is a schematic illustration of an alternative rotating detonation combustor 170 that may be used in RDC system 124 (shown in FIG. 2). In the exemplary embodiment, rotating detonation combustor 170 includes longitudinal centerline 134, and radially outer side wall 148 is oriented asymmetrically relative to longitudinal centerline 134. In addition, radially outer side wall 148 converges downstream from trailing edge 168 such that combustion chamber 150 further includes a diffuser portion 172 defined between annular portion 164 and throttling portion 166. As such, combustion chamber 150 includes annular portion 164 having an annular geometry and throttling portion 166 and diffuser portion 172 transitioning from an annular geometry to a non-annular and open geometry.

The systems and methods described herein facilitate efficiently converting the kinetic energy of high velocity RDC combustion products. More specifically, the RDC systems described herein include a plurality of rotating detonation combustors that are oriented to discharge the combustion products helically relative to a centerline of the RDC system. As such, pressure, velocity, and efficiency losses resulting from turning and deflecting the flow of combustion products is reduced. In addition, the plurality of rotating detonation combustors are oriented to facilitate satisfying flow angle requirements for a turbine configured to receive the flow of combustion gas.

An exemplary technical effect of the systems and methods described herein includes at least one of: (a) preserving the kinetic energy of high velocity RDC combustion products; (b) satisfying flow angle requirements of a turbine without the use of a separate array of turbine nozzle vanes; and (c) reducing high cycle fatigue of the turbine engine assembly.

Exemplary embodiments of RDC systems are provided herein. The systems and methods are not limited to the specific embodiments described herein, but rather, components of systems and/or steps of the methods may be utilized independently and separately from other components and/or steps described herein. For example, the configuration of components described herein may also be used in combination with other processes, and is not limited to practice with only ground-based, combined cycle power generation systems, as described herein. Rather, the exemplary embodiment can be implemented and utilized in connection with many applications where a RDC system may be implemented.

Although specific features of various embodiments of the present disclosure may be shown in some drawings and not in others, this is for convenience only. In accordance with the principles of embodiments of the present disclosure, any feature of a drawing may be referenced and/or claimed in combination with any feature of any other drawing.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A turbine engine assembly comprising:
a plurality of rotating detonation combustors configured for a rotating detonation process to occur to produce a flow of combustion gas, wherein said plurality of rotating detonation combustors are oriented such that the flow of combustion gas discharged therefrom flows helically relative to a centerline of the turbine engine assembly; and
a turbine coupled downstream from said plurality of rotating detonation combustors, said turbine configured to receive the flow of combustion gas.

2. The turbine engine assembly in accordance with claim 1, wherein each rotating detonation combustor has a longitudinal centerline, said each rotating detonation combustor oriented such that the longitudinal centerline is oriented tangentially relative to a radial axis of the turbine engine assembly.

3. The turbine engine assembly in accordance with claim 1 further comprising a plurality of flow conduits extending between said plurality of rotating detonation combustors and said turbine, said plurality of flow conduits configured to channel the flow of combustion gas from the plurality rotating detonation combustors towards said turbine.

4. The turbine engine assembly in accordance with claim 3, wherein said turbine has a turbine entrance flow angle defined within a predetermined range, said plurality of flow conduits oriented such that the flow of combustion gas is discharged therefrom at a flow angle defined within the predetermined range.

5. The turbine engine assembly in accordance with claim 3, wherein said plurality of flow conduits are configured to receive the flow of combustion gas at a first flow angle, and configured to discharge the flow of combustion gas at a second flow angle different from the first flow angle.

6. The turbine engine assembly in accordance with claim 3, wherein said plurality of rotating detonation combustors and said plurality of flow conduits are included in a one-to-one ratio in the turbine engine assembly such that a single flow conduit extends from each rotating detonation combustor.

7. The turbine engine assembly in accordance with claim 1, wherein said plurality of rotating detonation combustors comprises:
a first rotating detonation combustor comprising a first combustion chamber; and
a second rotating detonation combustor comprising a second combustion chamber, said first combustion chamber having a first diameter and said second combustion chamber having a second diameter greater than the first diameter.

8. A rotating detonation combustor comprising:
a center body; and
a radially outer side wall extending about said center body such that a combustion chamber is at least partially defined therebetween, wherein at least a portion of said radially outer side wall is oriented to converge towards said center body such that said combustion chamber comprises an annular portion and a throttling portion positioned downstream from said annular portion.

9. The rotating detonation combustor in accordance with claim 8, wherein said portion of said radially outer side wall is oriented obliquely relative to a centerline of the rotating detonation combustor.

10. The rotating detonation combustor in accordance with claim 8, wherein said center body comprises a trailing edge, said portion of said radially outer side wall extending past said trailing edge of said center body relative to a centerline of the rotating detonation combustor.

11. The rotating detonation combustor in accordance with claim 8, wherein said center body comprises a trailing edge that terminates within said throttling portion of said combustion chamber such that at least a portion of said throttling portion has a non-annular flow passage.

12. The rotating detonation combustor in accordance with claim 11, wherein said radially outer side wall converges downstream from said trailing edge such that said combustion chamber comprises a diffuser portion defined between said annular portion and said throttling portion.

13. The rotating detonation combustor in accordance with claim 11, wherein said center body further comprises a cylindrical portion and a tapered portion extending from said cylindrical portion.

14. The rotating detonation combustor in accordance with claim 8, wherein said throttling portion has a cross-sectional area less than a cross-sectional area of said annular portion.

15. A rotating detonation combustion system for use in a turbine engine assembly, said system comprising:
a plurality of rotating detonation combustors configured for a rotating detonation process to occur to produce a flow of combustion gas; and
a plurality of flow conduits coupled in flow communication with said plurality of rotating detonation combustors, wherein said plurality of rotating detonation combustors and said plurality of flow conduits are oriented such that the flow of combustion gas discharged from said plurality of flow conduits flows helically relative to a centerline of the turbine engine assembly.

16. The system in accordance with claim 15, wherein each rotating detonation combustor has a longitudinal centerline, said each rotating detonation combustor oriented such that the longitudinal centerline is oriented tangentially relative to a radial axis of the turbine engine assembly.

17. The system in accordance with claim 15, wherein said plurality of flow conduits are configured to receive the flow of combustion gas at a first flow angle, and configured to discharge the flow of combustion gas at a second flow angle different from the first flow angle.

18. The system in accordance with claim 15, wherein said plurality of rotating detonation combustors and said plurality of flow conduits are included in a one-to-one ratio in the turbine engine assembly such that a single flow conduit extends from each rotating detonation combustor.

19. The system in accordance with claim 15, wherein said plurality of rotating detonation combustors are configured to discharge the flow of combustion gas at a first velocity, and said plurality of flow conduits are configured to discharge the flow of combustion gas at a second velocity greater than the first velocity.

20. The system in accordance with claim 15, wherein each flow conduit progressively reduces in cross-sectional size along a centerline of the turbine engine assembly.
